(19) United States
(12) Patent Application Publication
(10) Pub. No.: US 2002/0078154 A1
(43) Pub. Date: Jun. 20, 2002

(54) WAP/IRC based instant collaboration tool

(76) Inventors: Safia Djennane, North Brunswick, NJ (US); Stuart Goose, Princeton, NJ (US)

Correspondence Address: Siemens Corporation, Intellectual Property Department, 186 Wood Avenue South, Iselin, NJ, 08830, US

(21) Appl. No.: 09/740,112

(22) Filed: Dec. 19, 2000

(51) Int. Cl. G06F 15/16; H04M 1/00

(52) U.S. Cl. 709/205; 379/158

(57) ABSTRACT

A method for synchronous wireless application protocol messaging is provided according to an embodiment of the present invention. The method provides each of two or more clients to a wireless application protocol chat server with an identification, creates a wireless markup language document including a client profile and a client posted message, and synchronizes each clients view of the wireless markup language document that the moderator is navigating.

### BACKGROUND OF THE INVENTION

1. Field of the Invention

The present invention relates to a system and method for message exchange, and more particularly a system and method of on-line collaboration using hand-held devices.

2. Description of Prior Art

The Internet has grown rapidly in recent years. The World Wide Web (WWW) has been widely embraced as a standard infrastructure over which a variety of applications can be deployed. A growing number of individuals are relying upon the WWW to perform daily activities. A similar revolution to that of the WWW is taking place within the domain of mobile telecommunications, with a burgeoning need for wireless Internet access, via the Wireless Application Protocol (WAP).

Chat Rooms and Instant Messaging have proved to be enormously popular Internet-based services. The predecessor to these services was the Internet Relay Chat (IRC), which is an IP-based service with support for distributed collaboration. Collaboration tools enable distributed users to work together using a variety of approaches. IRC provides a variety of mechanisms for users to collaborate across the WWW with friends, colleagues and others, both publicly and privately, by creating and subscribing to various “channels”, or chat rooms, to exchange text messages and transfer files. As such, IRC has become the de facto standard for collaboration in this arena.

At the same time, the interest in wireless devices, for example, phones, pagers, and Personal Digital Assistants (PDAs), as well as wireless services, has expanded. The Short Message Service (SMS), a form of paging, was developed for these wireless devices. The SMS enables two mobile terminals to exchange text messages including alphanumeric combinations. The ability to exchange SMS messages provides the convenience of enhanced connectivity. Unfortunately, SMS has fundamental technical limitations that make it an unsuitable technology for providing collaborative services. These limitations include: unidirectional messaging; limited fixed length messaging (e.g., limited to 160 characters); and point-to-point messaging.

Wireless networks have led to the development of the “unplugged Internet”. Supporting these developments is a new standard called the Wireless Application Protocol (WAP). WAP has emerged as a global standard for providing Internet communications and mobile telephony services on digital mobile phones, pagers, PDAs, and other wireless terminals. WAP is an open, global standard that empowers mobile users with wireless devices to access and interact with information and services. WAP technology is modeled on the WWW, but adapted for small devices with limited bandwidth and hardware capabilities.

WAP is a communications protocol and application environment. WAP is a specification for a set of communication protocols to standardize the way that wireless devices, such as cellular telephones and radio transceivers, can be used for Internet access, including e-mail, the WWW, newsgroups, and Internet Relay Chat (IRC). It can be built on operating systems such as PalmOS, EPOC, Windows CE, FLEXOS, OS/9, JavaOS, etc. Further, it provides service interoperability even between different device families (e.g., cellular telephone-to-PDA).

The WAP includes several layers of operability and functionality. These layers include the Wireless Application Environment (WAE); Wireless Session Layer (WSL); Wireless Transport Layer Security (WTLS); and Wireless Transport Layer (WTP).

Wireless Markup Language (WML) (also part of WAP), formerly called HDML (Handheld Devices Markup Language), is a language that allows the text portions of a Web page to be presented on a mobile device with wireless access, for example, a cellular telephone or PDA. WML works on top of standard data link protocols, such as Global System for Mobile Communication, code-division multiple access, and Time Division Multiple Access.

Currently no system or method is known to exist for handling multi-client collaboration over wireless networks. Therefore, the need exists for a system and method for enabling two or more mobile users to synchronously collaborate and exchange messages using mobile devices.

### SUMMARY OF THE INVENTION

A method for synchronous wireless application protocol messaging is provided according to an embodiment of the present invention. The method provides each of two or more clients to a wireless application protocol chat server an identification, creates a wireless markup language document (e.g., web page) including a client profile and a client posted message, and synchronizes each client's view of the wireless markup language document that the moderator is navigating.

The web page includes a hyperlink for allowing the client to navigate profiles and messages. A first client creates a collaboration space. The server provides a collaboration space for clients. The collaboration space includes a client moderator.

The method further defines a privilege for client, wherein the privilege defines access to document content. The method refreshes a client's view of the document after a defined period of time.

In one embodiment of the present invention, a system for mobile collaboration is provided. The system includes a wireless application protocol client connected to a wireless application protocol gateway, a world wide web server hosting a wireless application protocol Chat service for managing collaborators on a session-per-user basis, the world wide web server connected to the wireless application protocol gateway, and an internet relay chat server specified by the wireless application protocol client at the start of the session.

The world wide web server manages wireless application protocol client chat sessions, which in turn, can interact with multiple internet relay chat servers. The world wide web server generates a wireless markup language interface for the wireless application protocol clients. The world wide web server includes a wireless application protocol Chat agent based on Active Server Page technology.

According to an embodiment of the present invention, the method steps may be performed by a program storage device readable by machine, tangibly embodying a program of instructions executable by the machine to perform method steps for synchronous wireless application protocol based messaging.

### BRIEF DESCRIPTION OF THE DRAWINGS

Preferred embodiments of the present invention will be described below in more detail, with reference to the accompanying drawings:

FIG. 1 is an illustration of a system architecture according to an embodiment of the present invention;

FIG. 2 a flow chart of a WAP-Chat session according to an embodiment of the present invention; and

FIG. 3 is an illustrative example of user/moderator collaboration through a server according to an embodiment of the present invention.

### DETAILED DESCRIPTION OF PREFERRED EMBODIMENTS

One embodiment of the present invention provides a WAP-Chat application for supporting a Wireless Markup Language (WML) interface. It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform including hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

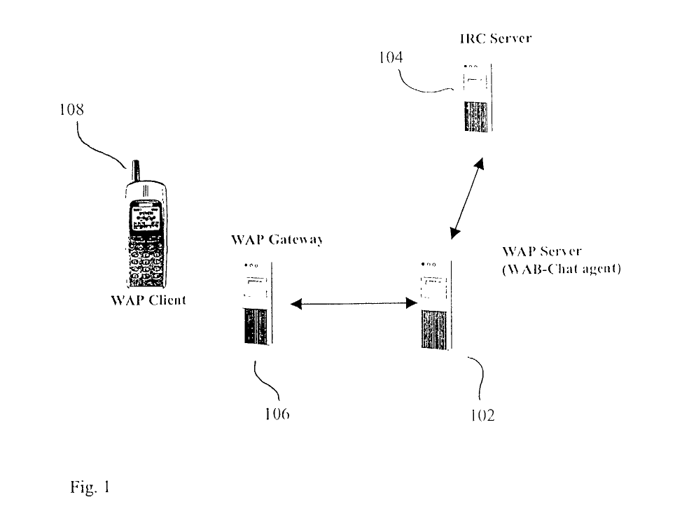

One embodiment of the present invention includes a WAP-Chat server. Referring to FIG. 1, the system architecture is based on a client-server model including a Web server 102 for hosting collaboration services and managing the client on a session-per-user basis, described below. The Web server 102 communicates with a chat server (IRC Server) 104 and with the WAP client 108 through a WAP gateway 106. The WAP gateway connects the WAP domains and the WWW, it encodes/decodes WAP content into a format recognized by the WAP device. This can depend, for example, on the operating system.

A WAP-Chat agent 102, according to an embodiment of the present invention, is provided for linking the WAP 106 and IRC 104 domains by mediating between WAP client functionality and the IRC server 104. The WAP-Chat agent runs on the Web server 102. The WAP-Chat agent 102 replies to requests and provides the service to the wireless device 108 (WAP client). The agent 102 is based on Active Server Page technology (or ASP) that enables handling WAP client requests (on the fly), forwarding requests to the IRC server 104, getting the servers' answers, and dynamically creating the adaptive WML answer page that can be displayed on WAP clients 108. The WAP-Chat agent 102 manages the collaboration between users on a session-per-user basis.

Under the session-per-user system, each session is identified by proprietary variables associated with the user. These variables can include, for example, the users identification information. When a user logs into a WAP room and the server identifies a user's information or profile (user information can be stored at the server, on the users device, or input manually by the user), this information is then used to construct a profile of the user for use within a session. A user profile may be incorporated in a session, for example, user name, or may be accessed like a file to reveal user information. Other variables are common and shared by other sessions, for example, a hyperlinked list of current users. The agent manages the collaboration by addressing and sharing variables with corresponding sessions, establishing the collaboration environment.

One embodiment of the present invention is based on a tiered architecture. A WAP client (tier 1) connects, via a WAP gateway, to the WWW server hosting the WAP-Chat service (tier 2) which manages collaborators on a session-per-user basis. The WWW server hosting the WAP-Chat service connects to the IRC server (tier 3) as specified by the user at the start of the session. The WAP-Chat WWW hosted application server manages user chat sessions, which in turn, can interact with multiple IRC servers. The WAP-Chat application server is also responsible for dynamically generating a WML interface for the WAP clients.

Various embodiments of the present invention will now be presented by way of application models. Before connecting to the WAP-Chat server and entering the WAP room, a user is asked to provide profile information to identify them within the connected community. For example, the information can include: the user's nickname; real name; email address; a picture; etc. A WAP-Chat agent can store profile information and generate a WML document whenever another user requests it. The profile can be stored temporarily or permanently at the agent, or alternatively saved on the client device for retrieval by other clients.

According to an embodiment of the present invention, the user can start a chat group (also called a channel) or join an existing one. Also included is a protocol for discovering existing chat groups and their members. For example, the client system can create its own radius of peers through a ping/pong exchange of information including, for example, IP addresses, connection speed, and topics of interest.

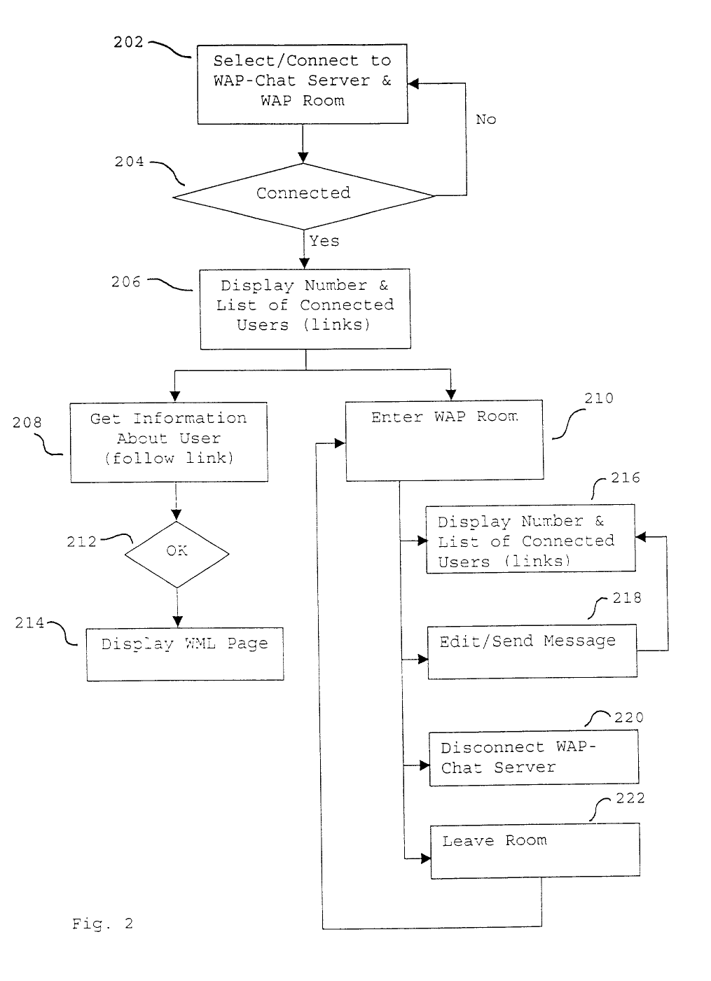

According to FIG. 2, a user can select/connect to a WAP-Chat server and any hosted WAP room 202. The system and method determine whether the connection was made 204. Once the connection is established with the server, the application displays a list of users already present in the WAP room as a set of hyperlinks 206. A user can follow a hyperlink directly to the corresponding user's WML home page 208. The system and method determine what information is available 212, for example, the information provided by a user prior to entering a chat room, and can display this information as a WML page 214.

Alternatively, the user can enter another WAP room 210. From within a WAP room, a user is able to: view the WAP room 216 in the same manner as in block 206 above; edit and send messages 218; disconnect from the WAP-Chat server 220; and/or leave the WAP room 222.

The WAP-Chat service allows subscribers to recognize other connected users within discussion sessions. WAP-Chat service provides an identification mechanism that, for example, exchanges user profiles.

User notification is another feature contemplated by the present invention. The WAP-Chat application can inform connected users of any important event that might be related to their discussion session. Also, a user joining/leaving the WAP room can be announced to the community, in addition the application can notify friends or co-workers (the community) that the user is are joining or leaving the room.

The present invention introduces a system and method of chatting (or collaborating) using a wireless device. It enables two or more mobile users to exchange messages. The model is based on a client-server architecture: user messages are introduced on the terminal and sent back to the server that dispatches the messages to wireless recipient(s) via the WAP protocol. The model implements a set of methods that coordinate and manage the collaboration between the connected user community and/or individual subscribers.

The WAP-Chat application, in one embodiment of the present invention, supports a synchronization mechanism called “co-browsing”, to help connected clients see the same WML document in a synchronized manner. Clients share a common space for collaboration purposes. Each client chooses, or is assigned a role to play in the collaboration, for example, one client is the chairman or moderator of the WAP room (seminar-like collaboration).

This technology can be applied in a variety of scenarios. For example, mobile access to corporate intranets and extranets enables employees and business partners to access data in a cost and time efficient manner. This is true both in terms of generic applications, for example, e-mail, calendaring, as well as for access to industry-specific and shareable applications. In a mobile working scenario, a mobile worker can request a manager's help because of on-site problems. The manager at a home-office can start a co-browsing session to guide them through the process of initiating a synchronized WAP-Chat application (or co-browsing), for example, using manual instructions.

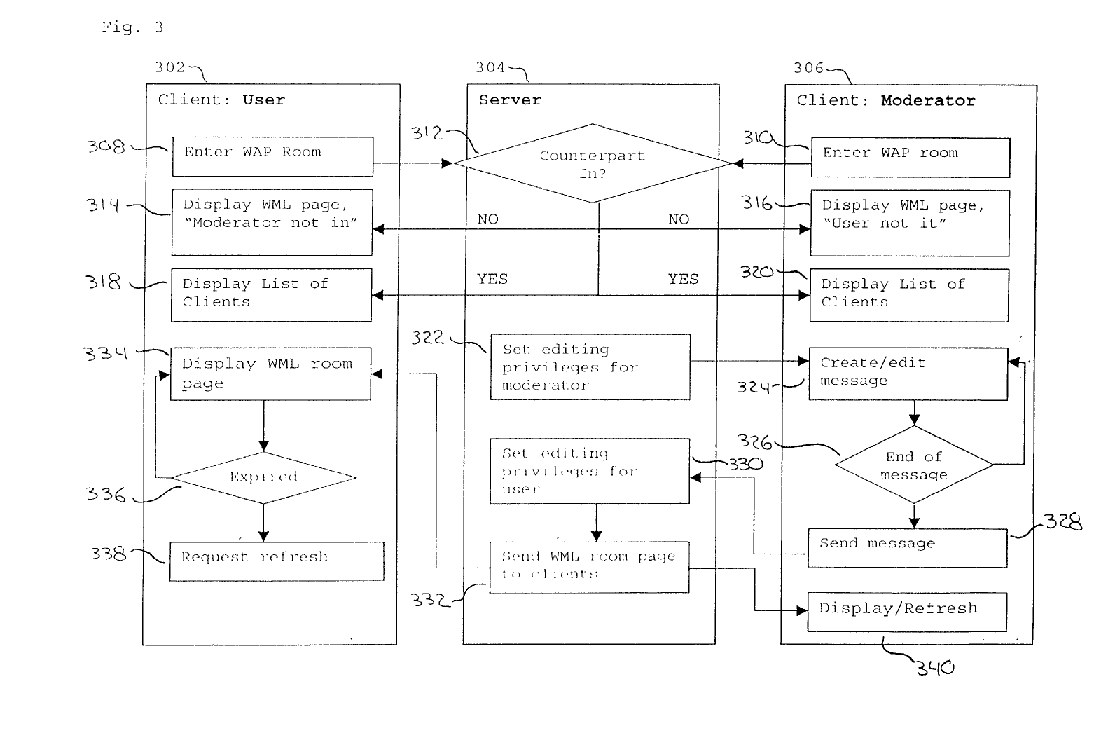

Referring to FIG. 3, an illustrative example of a co-browsing environment will now be described. A server 304 is provided for client interaction. A client can include, for example, a user 302 or a moderator 306. The clients, upon entering a WAP room 308 and 310 the system and method determine whether a counterpart is in, e.g., whether a moderator is available for users. There can be multiple clients within each defined group. A page will be displayed at the clients either listing other clients currently in the WAP room 318 and 320 or displaying a message informing the client that no counterpart is currently in the WAP room 314 and 316.

The server 304 can set the privileges for the moderator 322, for example, a moderator's access to files stored on the server. The moderator works within these privileges, and can for example create and/or edit messages to other clients 324, the moderator can save draft messages 326, and determine when to send the messages to the user 328. The server receives the messages from the moderator and applies a set of user privileges to the messages 330, so that for example, the user cannot edit the message but only reply. The WML room page, including any messages sent to the server, is sent to all clients for display 332. The display as viewed by a client can also be dependent on client privileges. For example, a message drafted and sent by a moderator can be directed to a group of users defined by their privileges where another group is excluded from receiving the messages because their privileges limit the content received. This can be used in a situation where, for example, sensitive information is directed to a sub-group of management users among a larger group management and employees, each sub-group with privileges designed to safeguard the content of the information.

At both the user and moderator, a WML room page can be displayed and refreshed (334, 336, 338 & 340). For example, at the user, the display of the WML room page can be refreshed based on whether the page has expired 336, e.g., based on the time lapse since the last refresh. The user then automatically requests a refresh 338 from the server.

One embodiment of the present invention supports centralized collaboration between peers. Distributed solutions generally require large hardware resources to support client side applications. The collaboration model according to the present invention, includes a main application (or agent) for managing clients. This complements a wireless terminal's limited capabilities (e.g., memory, bandwidth). The synchronization mechanism enabling the co-browsing feature is represented by a “co-browsing agent” running on the main server (WWW server). The agent manages the co-browsing feature by opening a single global session that is viewed by all connected users. The agent is based on Active Server Page technology (or ASP) where global variables can be shared by all open session instances.

The synchronization mechanism manages the co-browsing collaboration, allowing one user (called a moderator) to control the open session. The moderation supposes that all other connected users have lower privileges than the moderator (who manages the seminar-like collaboration). Users can send messages to the community under the moderator control but at the same time, the moderator messages are shared by all connected users. The co-browsing agent is implemented as an ASPage that recognizes the moderator and provides him/her with his/her privileges. The connected community shares moderator transactions (stored in global variables) during the open session, providing the co-browsing feature.

Market studies have shown a clear growth of demand for access to more information and services on mobile phones. However, most of the mobile data users currently use tools having limited functionality (such as SMS) compared to full Internet mobile services. The present invention exchanges instant messages (or to chat) on wireless platforms. The invention also presents a synchronized technique for collaborating in a seminar like model. The present invention has clear benefits for the general public, for entertainment, education, and business. In addition, tele-collaboration and conferencing between mobile professionals benefits consumers of wireless data.

Having described embodiments of a system and method for providing handheld device chat capabilities, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set for in the appended claims.

What is claimed is:

1. A method for synchronous wireless application protocol messaging comprising the steps of:
providing each of two or more clients to a wireless application protocol chat server an identification;
creating a wireless markup language document including a client profile and a client posted message; and
synchronizing each client's view of the wireless markup language document.

2. The method of claim 1, wherein the document includes a hyperlink for allowing the client to navigate profiles and messages.

3. The method of claim 1, wherein a first client creates a collaboration space.

4. The method of claim 1, wherein the server provides a collaboration space for clients.

5. The method of claim 4, wherein the collaboration space includes a client moderator.

6. The method of claim 1, further comprising the step of defining a privilege for client, wherein the privilege defines access to document content.

7. The method of claim 1, further comprising the step of refreshing a clients view of the document after a defined period of time.

8. A system for synchronous mobile collaboration comprising:
a wireless application protocol client connected to a wireless application protocol gateway;
a world wide web server hosting a wireless application protocol Chat service for managing collaborators on a session-per-user basis, the world wide web server connected to the wireless application protocol gateway; and
an internet relay chat server specified by the wireless application protocol client at the start of the session.

9. The system of claim 8, wherein the world wide web server manages wireless application protocol client chat sessions, which in turn, can interact with multiple internet relay chat servers.

10. The system of claim 9, wherein the world wide web server generates a wireless markup language interface for the wireless application protocol clients.

11. The system of claim 8, wherein the world wide web server comprises a wireless application protocol Chat agent based on Active Server Page technology.

12. A program storage device readable by machine, tangibly embodying a program of instructions executable by the machine to perform method steps for synchronous wireless application protocol based messaging, the method steps comprising:
providing each of two or more clients to a wireless application protocol chat server an identification;
creating a wireless markup language web page including a client profile and a client posted message; and
synchronizing each client's view of the wireless markup language web page.

13. The method steps of claim 12, wherein the web page includes a hyperlink for allowing the client to navigate profiles and messages.

14. The method steps of claim 12, wherein a first client creates a collaboration space.

15. The method steps of claim 12, wherein the server provides a collaboration space for clients.

16. The method steps of claim 15, wherein the collaboration space includes a client moderator.

17. The method steps of claim 12, further comprising computer readable program code for defining a privilege for client, wherein the privilege defines access to web page content.

18. The method steps of claim 12, further comprising computer readable program code for refreshing a clients view of the web page after a defined passage of time.
